(19) United States
(12) Patent Application Publication
(10) Pub. No.: US 2005/0034890 A1
(43) Pub. Date: Feb. 17, 2005

(54) Electronic conducting element

(76) Inventor: Ted Ju, Taipei (TW)

Correspondence Address: TROXELL LAW OFFICE PLLC, 5205 LEESBURG PIKE, SUITE 1404, FALLS CHURCH, VA, 22041, US

(21) Appl. No.: 10/643,477

(22) Filed: Aug. 15, 2003

(51) Int. Cl. H02G 3/06

(52) U.S. Cl. 174/94 R

(57) ABSTRACT

An electronic conducting element includes a body, a plastic arm, and a welding element. Wherein the plastic arm includes a connecting element bending extended from the bottom of the body, a plastic element extended up from the connecting element, and a welding element extended down from the bottom of the body. Whereby the electronic conducting element has an improved and simple manufacturing process, a better holding reliability, reduced contact electronic resistance, and effective contact and conduction with independent elements.

### BACKGROUND OF THE INVENTION

1. Field of the Invention

The present invention relates to an electronic conducting element for effectively contacting and conducting with other independent elements.

2. Description of the Prior Art

There are many methods for connecting an electronic connector and other independent elements, and one of them is pressing contact. As FIGS. 1 and 2 show, the prior art conducting element including a holding element, a contact arm upward extending from the holding element, a linkage arm bending extending from one side of the contact arm, a welding element bending down one-forth circle from the holding element, and the welding element for a connecting welding material, such as a tin ball.

The first step of installation is to arrange the electronic conducting element in the insulating housing via the holding element, and then weld the electronic conducting element and the circuit board. When the other independent elements are pressed on the end of the contact, they can contact and conduct electric. The prior art does, however, have three disadvantages: first, the length of the holding element is too short to hold the insulating housing due to the limitation of the electronic conduct element; second, because the loading of the end of the linkage arm is limited, the positive force of the electronic conduct element is not enough to lead an excessive contact electronic resistance, and even reduces the effect of the contact between the electronic conduct element and the independent elements; third, the process involves many steps and the structure is thus harder to manufacture.

### SUMMARY OF THE DISCLOSURE

In accordance with the present invention provides an electronic conducting element including a body, a plastic arm, and a welding element. The plastic arm includes a connecting element bending and extending from the bottom of the body, a plastic element extending up from the connecting element, and a welding element extending down from the bottom of the body.

It is an object and benefit of the present invention to provide an electronic conducting element having an improved and simple manufacturing process, a better holding reliability, reduced contact electronic resistance, and effective contact and conduction with independent elements. Other benefits and advantages will become apparent to those skilled in the art upon a reading of this specification.

### BRIEF DESCRIPTIONS OF THE DRAWINGS

These and other features, aspects, and advantages of the present invention will become better understood with regard to the following description, appended claims, and accompanying drawings where:

FIG. 1 is a stereo picture of a conventional electronic conducting element;

FIG. 2 is a perspective view of a conventional electronic conducting element;

FIG. 3 is a stereo picture of the first embodiment of the present invention;

FIG. 4 is an assembled stereo picture of the first embodiment of the present invention installed in an insulating housing;

FIG. 5 is a front view of the first embodiment of the present invention installed in an insulating housing;

FIG. 6 is a stereo picture of the second embodiment of the present invention;

FIG. 7 is a stereo picture of the third embodiment of the present invention;

FIG. 8 is a stereo picture of the forth embodiment of the present invention;

FIG. 9 is a stereo picture of the fifth embodiment of the present invention; and

FIG. 10 is a stereo picture of the sixth embodiment of the present invention.

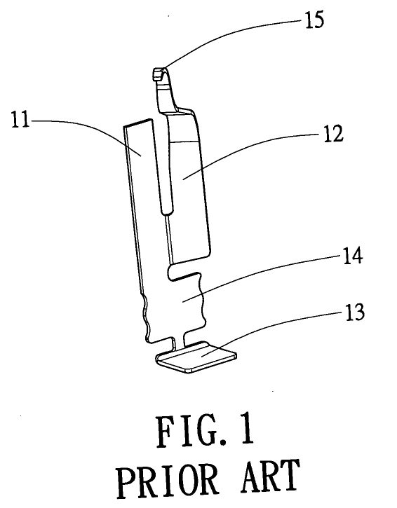

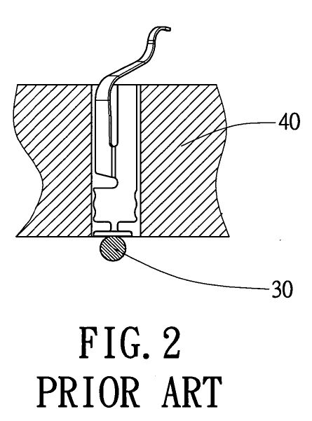

### DETAILED DESCRIPTION OF THE PREFERRED EMBODIMENTS

Referring now to the drawings provided for purposes of illustrating preferred embodiments of the invention only and not for purposes of limitation, the FIGURES show an electronic conducting element with improved security features.

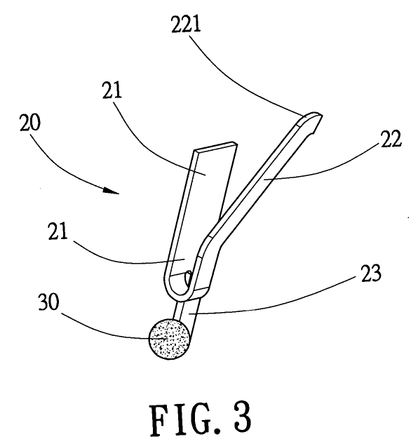

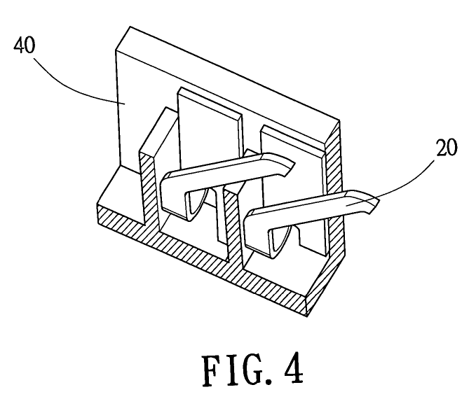

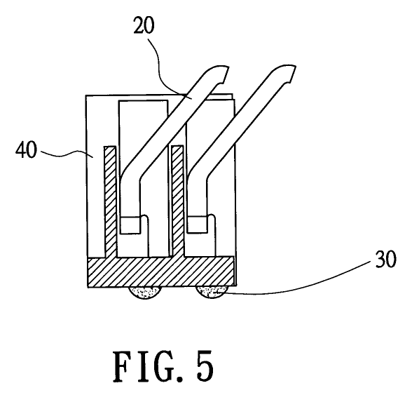

More specifically, FIGS. 3, 4, and 5 show an electronic conducting element 20 including a body 21, a plastic arm 22, and a welding element 23. The plastic arm 22 and the welding element 23 extend down from the bottom of the body 21. The plastic arm 22 further has a connecting element 222 extending from the bottom of the body 21, a plastic element 223 extending up from the connecting element 222 bending up, and a contact element 221 pressed contact with other independent elements (not shown). A welding material 30 is embedded in the welding element 23 to weld an electronic connector with a circuit board (not shown).

The body 21 and the plastic arm 22 are parallel to each other, and are as tall as the insulating housing 40 to hold the electronic conducting element firmly within the insulating housing 40. When other independent elements press the electronic conducting element 20, the electronic conducting element 20 is bent to the side as the plastic element 223 inclines to one side with a predetermined angle. The contact impedance is thus reduced and has a large positive force making the electronic conducting element effectively contact other independent elements. Moreover, the electronic conducting element is easily made by only two manufacturing steps, pressing and bending.

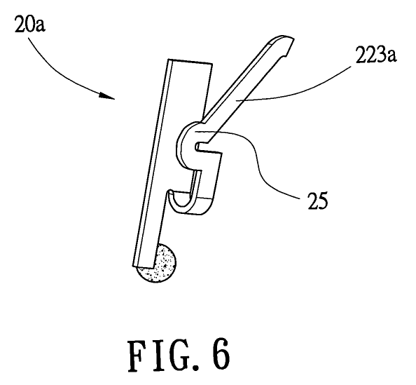

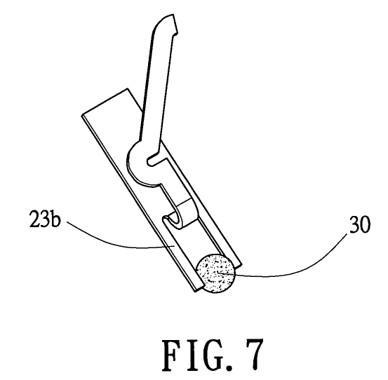

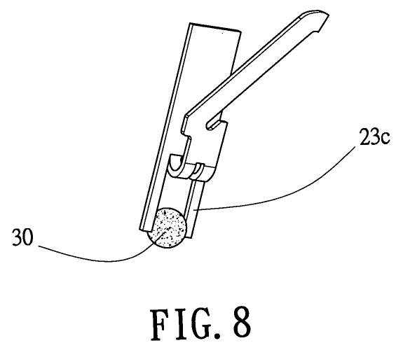

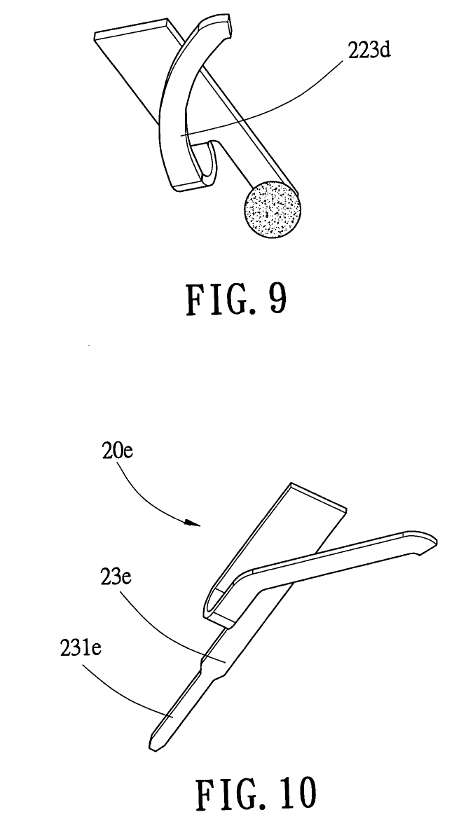

The other preferred embodiments of the invention are shown in FIGS. 6-10. FIG. 6 shows an arced bend element 25 being formed before the plastic element 223a inclines by a predetermined angle to one side to improve elasticity of the electronic conducting element 20a. FIGS. 7 and 8 show the welding elements 23b and 23c extending to two bars to connect welding material 30. FIG. 9 shows that the plastic element 223d can be formed in an arc or other shapes. FIG. 10 shows the welding element 23e further having a bar 131e downward extending and passing through circuit board (not shown) to weld the electronic conducting element 20e and the circuit board.

Although the present invention has been described with reference to the preferred embodiment therefore, it will be understood that the invention is not limited to the details thereof. Various substitutions and modification s have suggested in the foregoing description, and other will occur to those of ordinary skill in the art. Therefore, all such substitutions and modifications are intended to be embrace within the scope of the invention as defined in the appended claims.

1. An electronic conducting element comprising:
a body;
a plastic arm having a connecting element bending and extending from a bottom of the body and a plastic element extending up from the connecting element; and,
a welding element extending downward from the bottom of the body.

2. The electronic conducting element as claimed in claim 1, wherein the plastic element of the plastic arm inclines by a predetermined angle to one side.

3. The electronic conducting element as claimed in claim 1, wherein the plastic element of the plastic arm is bent with a predetermined angle into an arc.

4. The electronic conducting element as claimed in claim 3, wherein the plastic arm includes a contact extending from an end thereof.

5. The electronic conducting element as claimed in claim 4, wherein a welding material is embedded in an end of the welding element.

6. The electronic conducting element as claimed in claim 4, wherein the welding element further comprises a bar downward-extending from the end thereof.

7. The electronic conducting element as claimed in claim 4, wherein the plastic arm further comprises an arc-bending element between the connecting element and the plastic element.
